(19) United States
(12) Patent Application Publication
(10) Pub. No.: US 2006/0043873 A1
(43) Pub. Date: Mar. 2, 2006

(54) Electron emission device

(76) Inventor: Seong-Yeon Hwang, Suwon-si (KR)

Correspondence Address: CHRISTIE, PARKER & HALE, LLP, PO BOX 7068, PASADENA, CA, 91109-7068, US

(21) Appl. No.: 11/211,328

(22) Filed: Aug. 24, 2005

(30) Foreign Application Priority Data
Aug. 30, 2004 (KR) 10-2004-0068519

(51) Int. Cl. H01J 63/04; H01J 1/62

(52) U.S. Cl. 313/495

(57) ABSTRACT

An electron emission device includes a substrate, first and second electrodes formed on the substrate and insulated from each other by a first insulating layer interposed between them. Electron emission regions electrically coupled to the first electrode, and a focusing electrode formed on the first and second electrodes. A second insulating layer is interposed between the focusing electrode and the first and second electrodes and has openings exposing the electron emission regions. The first and second insulating layers each have a thickness of 1 μm or more. The first insulating layer may have a softening temperature higher than the softening temperature of the second insulating layer by 30° C. or more.

### CROSS REFERENCE TO RELATED APPLICATION

This application claims priority to and the benefit of Korean Patent Application No. 10-2004-0068519 filed on Aug. 30, 2004 in the Korean Intellectual Property Office, the entire content of which is incorporated herein by reference.

### BACKGROUND OF THE INVENTION

1. Field of the Invention

The present invention relates to an electron emission device, and in particular, to an electron emission device which has a focusing electrode for focusing electron beams.

2. Description of Related Art

Generally, electron emission devices are classified into a first type, where a hot cathode is used as an electron emission source, and a second type, where a cold cathode is used as the electron emission source. Among the second type electron emission devices are known a field emitter array (FEA) type, a surface conduction emitter (SCE) type, a metal-insulator-metal (MIM) type, and a metal-insulator-semiconductor (MIS) type.

The FEA type electron emission device is based on the principle that when a material having a low work function or a high aspect ratio is used as an electron emission source, electrons are easily emitted from the material under the vacuum atmosphere due to the electric field. A sharp-pointed front-end tip structure based on molybdenum or silicon, or a carbonaceous material, such as carbon nanotube, graphite and diamond-like carbon, has been developed to be used as the electron emission source.

With this tip structure, as the electric fields are focused to the sharp-pointed front ends thereof, electrons are easily emitted from those ends. However, as the tip structure is fabricated through a semiconductor process, the processing steps are complicated, and in larger devices, it is difficult to obtain uniform device quality.

In this connection, trials have been recently made to replace a carbonaceous material for the tip structure. Particularly, as the carbon nanotube involves extremely small end curvature of 100 Å (where 1 Å=10⁻⁸ cm) and emits electrons well even under the low electric field of 1-10V/μm, it is expected to be an ideal electron emission material.

In an FEA type electron emission device, cathode electrodes are formed on a first substrate, and electron emission regions are formed on the cathode electrodes. An insulating layer is formed on the cathode electrodes with opening portions exposing the electron emission regions, and gate electrodes are formed on the insulating layer. An anode electrode and phosphor layers are formed on a second substrate.

When predetermined driving voltages are applied to the cathode and the gate electrodes, electric fields are formed around the electron emission regions due to the voltage difference between the two electrodes so that electrons are emitted from the electron emission regions. The emitted electrons are attracted by the high voltage applied to the anode electrode (about several hundred to several thousand volts), and directed toward the second substrate, thereby colliding against the phosphor layers and causing them to emit light.

It is desirable in an electron emission device for the insulating layer to have a sufficiently large thickness. This is because when the insulating layer has a sufficiently large thickness and the gate electrodes have sufficient height with respect to the electron emission regions, electrons are emitted from the electron emission regions well, while inhibiting the diffusion of the electron beams.

Nevertheless, when the electrons emitted from the electron emission regions of the first substrate proceed toward the second substrate, they are diffused, and partially reach incorrect phosphor layers neighboring the target pixel. The incorrect phosphor layers are thereby light-emitted, causing deterioration of the screen color representation.

In order to solve such a problem, a focusing electrode for controlling the electron beams is formed on the gate electrodes while interposing an insulating layer. For explanatory convenience, the insulating layer disposed between the cathode and the gate electrodes is called the “first insulating layer,” and the insulating layer disposed between the gate and the focusing electrodes is called the “second insulating layer.” The second insulating layer spaces the focusing electrode from the electron emission regions by a predetermined distance. Opening portions are formed at the focusing electrode and the second insulating layer to create electron beam migration routes.

Accordingly, as the electrons emitted from the electron emission regions pass through the opening portions of the second insulating layer and the focusing electrode, the diffusion angle of the electrons is reduced due to the negative (−) electric potential of the focusing electrode, thereby preventing beam diffusion and allowing effective focusing.

In order to obtain better electron beam focusing efficiency, the second insulating layer for insulating the gate and the focusing electrodes from each other can be formed with a sufficiently large thickness such that the focusing electrodes are spaced apart from the electron emission region by a large distance.

However, when the insulating layers are all formed with a large thickness, the stability of the structure, on which the first and second insulating layers are deposited, is deteriorated, thereby limiting the improvement in electron beam focusing efficiency. This is because when the two insulating layers are sequentially formed, the previously formed insulating layer and the gate electrodes may be deformed or broken, due to the firing temperature of the later-formed insulating layer.

### SUMMARY OF THE INVENTION

In an exemplary embodiment of the present invention, an electron emission device stabilizes the deposition structure of first and second insulating layers, and enhances the emission characteristic of electron emission regions and the electron beam focusing efficiency.

In this embodiment, the electron emission device includes a first substrate, and first and second electrodes formed on the first substrate and insulated from each other by a first insulating layer that is interposed between them. Electron emission regions are electrically coupled to the first electrodes. A focusing electrode is formed on the first and second electrodes, and a second insulating layer is interposed between the focusing electrode and the first and second electrodes. The second insulating layer has openings that expose the electron emission regions. The first and second insulating layers each have a thickness of 1 μm or more, and the first insulating layer has a softening temperature higher than the softening temperature of the second insulating layer by 30° C. or more.

In another embodiment, the electron emission device includes a first substrate, and first and second electrodes formed on the first substrate and insulated from each other by a first insulating layer that is interposed between them. Electron emission regions are electrically coupled to the first electrodes. A focusing electrode is formed on the first and second electrodes, and a second insulating layer is interposed between them having openings that expose the electron emission regions. The first and second insulating layers each have a thickness of 1 μm or more, and the first insulating layer has a firing temperature higher than the firing temperature of the second insulating layer by 50° C. or more.

The first insulating layer in one embodiment has a softening temperature higher than the firing temperature of the second insulating layer. In another embodiment, the first insulating layer has a thickness of 3 μm or more, and the second insulating layer has a thickness of 5 μm or more.

The electron emission regions include a material selected from the group consisting of carbon nanotube, graphite, graphite nanofiber, diamond, diamond-like carbon, C₆₀, and silicon nanowire.

The electron emission further includes at least one anode electrode that is formed on a second substrate facing and spaced from the first substrate, and phosphor layers are formed on a surface of the anode electrode.

### BRIEF DESCRIPTION OF THE DRAWINGS

FIG. 1 is a partial exploded perspective view of an electron emission device according to a first embodiment of the present invention.

FIG. 2 is a partial sectional view of the electron emission device according to the first embodiment shown in FIG. 1.

FIG. 3 is a partial sectional view of an electron emission device according to another embodiment of the present invention.

FIG. 4 is an electron microscope photograph illustrating the deformation degree of a gate electrode due to a first set of firing temperatures of the first and second insulating layers.

FIG. 5 is an electron microscope photograph illustrating the deformation degree of a gate electrode due to a second set of firing temperatures of the first and second insulating layers.

FIG. 6 is an electron microscope photograph illustrating the deformation degree of a gate electrode due to a third set of firing temperatures of the first and second insulating layers.

FIGS. 7A to 7D schematically illustrate the steps of fabricating the electron emission device shown in FIG. 1.

### DETAILED DESCRIPTION

The present invention will be described more fully hereinafter with reference to the accompanying drawings, in which exemplary embodiments of the invention are shown.

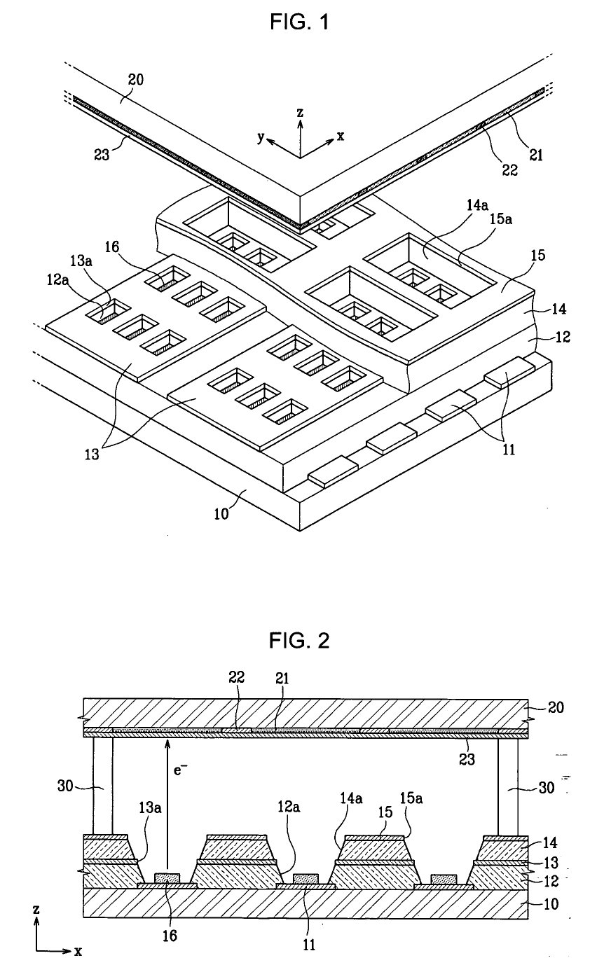

Referring to FIGS. 1 and 2, the electron emission device includes first and second substrates 10 and 20 arranged parallel to each other and separated by a predetermined distance to define an inner space. An electron emission structure is provided at the first substrate 10 to emit electrons, and a light emission or display structure at the second substrate 20 is provided to emit visible rays in response to the electrons, thereby emitting light or displaying the desired images.

Specifically, first electrodes 11 (referred to hereinafter as “cathode electrodes”) are stripe-patterned on the first substrate 10 in a first direction (in the y axis direction of the drawing), and a first insulating layer 12 is formed on the entire surface of the first substrate 10 and covering the cathode electrodes 11. Second electrodes 13 (referred to hereinafter as “gate electrodes”) are stripe-patterned on the first insulating layer 12 in a second direction crossing the first direction.

The crossed regions of the cathode and the gate electrodes 11 and 13 are defined herein as pixel regions, and electron emission regions 16 are formed on the cathode electrodes 11 at those pixel regions. Opening portions 12a and 13a are formed in the first insulating layer 12 and the gate electrodes 13 corresponding to the electron emission regions 16 to expose the electron emission regions 16.

FIG. 1 illustrates the case where three electron emission regions are placed at each pixel region, and the opening portion formed in the first insulating layer and the gate electrode is shaped as a rectangle, but the number of the electron emission regions and the shape of the opening portion of the first insulating layer and the gate electrode are not limited thereto, and may be altered in various manners.

In this embodiment, the electron emission regions 16 are formed with a material emitting electrons when applied with an electric field under the vacuum atmosphere, such as a carbonaceous material and a nanometer-sized material. The electron emission regions 16 are preferably formed with carbon nanotube, graphite, graphite nanofiber, diamond, diamond-like carbon, C₆₀, silicon nanowire, or a combination thereof.

The electron emission regions 16 may be formed through screen printing, chemical vapor deposition, sputtering, or direct growth. The electron emission region formed by the screen printing has a thickness of about 3 μm, and that formed by another formation technique has a thickness smaller than the former.

A second insulating layer 14 and a focusing electrode 15 are formed on the gate electrodes 13 and the first insulating layer 12, and opening portions 14a and 15a are also formed at the second insulating layer 14 and the focusing electrode 15, respectively, to expose the electron emission regions 16.

As shown in FIG. 1, the second insulating layer 14 and the focusing electrode 15 have one opening portion at each pixel. Alternatively, the opening portions may be in one to one correspondence with the electron emission regions. In the latter case, the opening portions of the second insulating layer 14 and the focusing electrode 15 are arranged in one to one correspondence with the opening portions 12a and 13a of the first insulating layer 12 and the gate electrodes 13.

In order to enhance the emission efficiency of the electron emission regions 16, the first insulating layer 12 may be formed with a thickness of 1 μm or more. In some embodiments, the thickness is 3 μm or more. In order to enhance the electron beam focusing efficiency of the focusing electrode 15 while preventing the electron emission regions 16 from being affected by the anode electric field, the second insulating layer 14 may be formed with a thickness of 1 μm or more, or, in some embodiments, with a thickness of 5 μm or more.

The first insulating layer 12 has a thickness greater than the thickness of the electron emission region 16, and in case the electron emission region 16 is formed by the screen printing, the thickness of the first insulating layer 12 may be established to be 3 μm or more.

As shown in FIG. 1, the focusing electrode 15 is formed on the entire surface of the first substrate 10. Alternatively, the focusing electrode 15 may be patterned with multiple portions. In either case, opening portions 14a and 15a are also respectively formed at the second insulating layer 14 and the focusing electrodes 15 to expose the electron emission regions 16 on the first substrate 10.

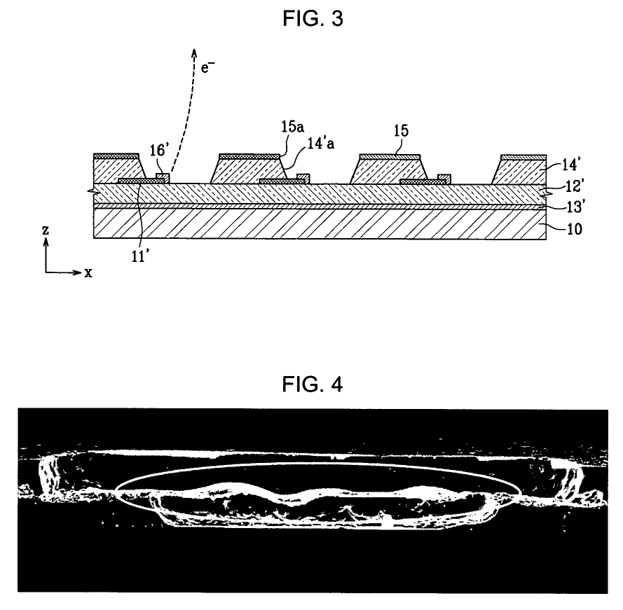

As explained above, the gate electrode 13 is placed over the cathode electrode 11 while interposing the first insulating layer 12. As shown in FIG. 3, the gate electrode 13′ may be placed under the cathode electrode 11′ on the first substrate 10 while interposing the first insulating layer 12′, and in this case, the electron emission region 16′ contacts the one-sided periphery of the cathode electrode 11′.

Even with the structure shown in FIG. 3, a second insulating layer 14′ and a focusing electrode 15 are formed on the first insulating layer 12′ and the cathode electrode 11′, and opening portions 14a′ and 15a are formed at the second insulating layer and the focusing electrode 15 to expose the electron emission regions 16′.

In this embodiment, the first and second insulating layers 12′ and 14′ are formed with the above-identified thickness such that the gate and the focusing electrodes 13′ and 15 are spaced apart from the electron emission regions 16′ with a sufficiently large distance. The first and second insulating layers 12′ and 14′ are formed with various different kinds of materials involving various different thermal characteristics.

Particularly in this embodiment, the first insulating layer 12′ is formed with an insulating material having a softening temperature (Ts), at which the frit of the insulating layer begins to be melted, higher than that of the second insulating layer 14′ by 30° C. or more. This is because when the second insulating layer 14′ is formed after the formation of the first insulating layer 12′, the breakage or deformation of the first insulating layer 12′ is inhibited to thereby stabilize the deposition structure of the first and second insulating layers 12′ and 14′.

In order to stabilize the deposition structure of the first and second insulating layers 12′ and 14′, the first insulating layer 12′ is formed with an insulating material having a firing temperature higher than that of the second insulating layer 14′ by 50° C. or more. The firing temperature of the insulating material is usually established to be higher than the softening temperature thereof by 50° C. or more, but such a temperature difference may be slightly varied per the respective materials.

The first insulating layer 12′ may be formed with an insulating material having a firing temperature higher than that of the second insulating layer 14′ by 50° C. or more, and a softening temperature higher than that of the second insulating layer 14′ by 30° C. or more. In this case, the softening temperature of the first insulating layer 12′ is higher than the firing temperature of the second insulating layer 14′.

The first and second insulating layers 12′ and 14′ are formed with an oxide material mainly containing a frit, such as PbO, SiO₂, B₂O₃, Al₂O₃, and TiO₂. With the proper composition of the respective materials, the first and second insulating layers 12′ and 14′ may be differentiated in firing and softening temperatures.

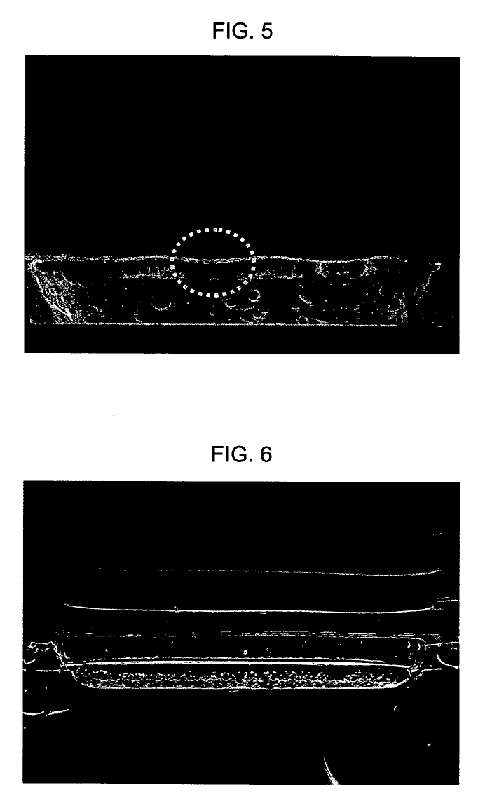

FIG. 4 illustrates the case where the first and second insulating layers have the same firing temperature of 550° C., and FIG. 5 illustrates the case where the first insulating layer has a firing temperature of 550° C., and the second insulating layer has a firing temperature of 570° C. FIG. 6 illustrates the case where the first insulating layer has a firing temperature of 520° C., and the second insulating layer has a firing temperature of 570° C.

As shown in the drawings, with the case illustrated in FIG. 4, where the first and second insulating layers have the same firing temperature, and the case illustrated in FIG. 5, where the firing temperature of the first insulating layer is higher than that of the second insulating layer by 20° C., the gate electrodes are seriously deformed. In the case illustrated in FIG. 6, however, where the firing temperature of the first insulating layer is higher than that of the second insulating layer by 50° C., the gate electrodes are very slightly deformed. The oval-shaped regions of FIGS. 4 and 5 indicate the wrinkled portions of the gate electrodes.

Referring again to FIGS. 1 and 2, phosphor layers 21 and an anode electrode 23 are formed on the surface of the second substrate 20 facing the first substrate 10. The anode electrode 23 receives a plus voltage of several tens to several thousand volts, and accelerates the electrons emitted from the electron emission regions 16 toward the phosphor layers 21.

In this embodiment, the phosphor layers 21 are colored with red, green and blue, and black layers 22 are disposed between the neighboring phosphor layers 21 to enhance the contrast. An anode electrode 23 is formed on the phosphor layers 21 and the black layers 22 are formed with a metallic material, such as aluminum. The metallic anode electrode 23 reflects the visible rays radiated toward the first substrate 10 from the phosphor layers 21 to the side of the second substrate 20, thereby enhancing the screen luminance.

The anode electrode may be formed with a transparent conductive material, such as indium tin oxide (ITO). In this case, the anode electrode is placed on the surfaces of the phosphor layers and the black layers facing the second substrate. The anode electrode may be formed on the entire surface of the second substrate, or partitioned into multiple portions with a predetermined pattern.

The first and second substrates 10 and 20 are spaced apart from each other by a distance, and attached to each other with a sealing material, such as a frit. The inner space between the first and second substrates 10 and 20 is exhausted to be in a vacuum state, thereby constructing an electron emission device. A plurality of spacers 30 are arranged at the non-light emission regions between the first and second substrates 10 and 20 to maintain a constant distance between the substrates.

With this embodiment, when driving voltages are applied to the cathode and the gate electrodes 11 and 13, electric fields are formed around the electron emission regions 16 due to the voltage difference between the two electrodes to emit electrons from the electron emission regions 16. The diffusion angle of the emitted electrons is reduced due to the negative (−) voltage of several tens of volts applied to the focusing electrode 15, and is thereby focused. The focused electrons are attracted by the high voltage applied to the anode electrode 22, and are directed toward the second substrate 20, thereby landing on the phosphor layers 21 at the intended pixels and light-emitting them.

At this time, as the first insulating layer 12 has a thickness of 1 μm or more, in some embodiments 3 μm or more, and the second insulating layer 14 has a thickness of 1 μm or more, in some embodiments 5 μm or more, the gate and the focusing electrodes 13 and 15 are at a sufficient distance from the electron emission region 16. Furthermore, the first and second insulating layers 12 and 14 have a stable deposition structure due to the difference between the firing and softening temperatures thereof, thereby increasing the electron beam focusing efficiency.

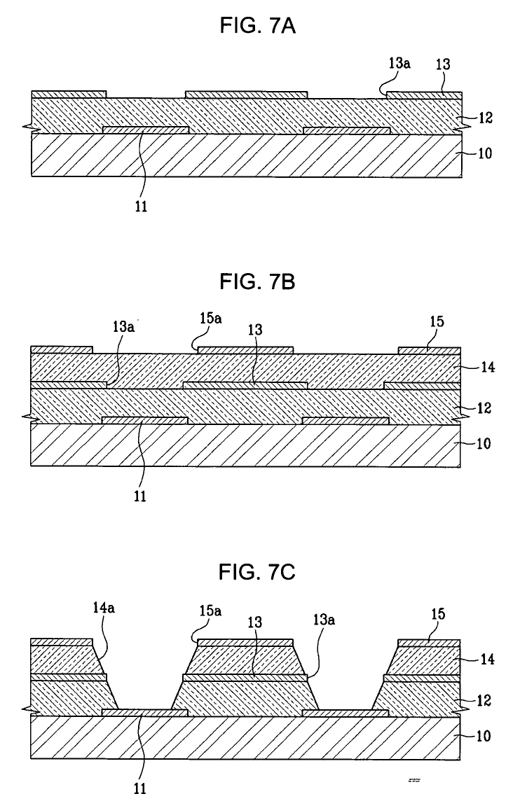

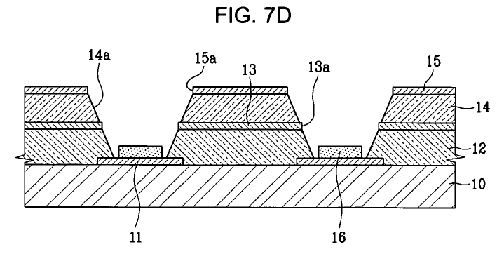

A method of manufacturing an electron emission device according to the embodiment shown in FIGS. 1 and 2 will now be explained with reference to FIGS. 7A to 7D.

As shown in FIG. 7A, cathode electrodes 11 are stripe-patterned on the first substrate 10 in a first direction, and a first insulating layer 12 is formed on the entire surface of the first substrate 10 and covers the cathode electrodes 11. The first insulating layer 12 is formed with a thickness of 1 μm or more, in some embodiments 3 μm or more, using screen printing, laminating, or a doctor blade.

The first insulating layer 12 is formed with a material different in thermal property from the second insulating layer to be formed afterward. In one embodiment, the first insulating layer 12 is formed with an oxide material having a firing temperature higher than that of the second insulating layer by 50° C. or more, or a softening temperature higher than that of the latter by 30° C. or more.

The first insulating layer 12 may be formed with an insulating material having a firing temperature higher than that of the second insulating layer by 50° C. or more, and a softening temperature higher than that of the second insulating layer by 30° C. or more. In one embodiment, the softening temperature of the first insulating layer 14 is higher than the firing temperature of the second insulating layer.

Thereafter, a gate electrode material layer is formed on the first insulating layer 12 with a metallic material, such as chromium Cr, and patterned through photolithography and etching, thereby forming gate electrodes 13 stripe-patterned in a second direction crossing the cathode electrodes 11 with opening portions 13a at the crossed pixel regions of the cathode and the gate electrodes 11 and 13.

As shown in FIG. 7B, a second insulating layer 14 is formed on the first insulating layer 12 such that it covers the gate electrodes 13. Like the first insulating layer 12, the second insulating layer 14 is formed with a thickness of 1 μm or more, in some embodiments 5 μm or more, using screen printing, laminating, or a doctor blade.

A focusing electrode 15 is then formed on the second insulating layer 14, and etched at the portions thereof corresponding to the opening portions 13a of the gate electrodes 13 through photolithography and etching, thereby forming opening portions 15a at the focusing electrode 15.

As shown in FIG. 7C, the second insulating layer 14 exposed through the opening portions 15a of the focusing electrode 15 is etched, thereby forming opening portions 14a at the second insulating layer 14. The first insulating layer 12 exposed through the opening portions 13a of the gate electrodes 13 is etched, thereby forming opening portions 12a at the first insulating layer 12. Consequently, the cathode electrodes 11 are partially exposed at the portions thereof to be formed with electron emission regions 16.

As shown in FIG. 7D, electron emission regions are formed on the exposed portions of the cathode electrodes 11.

The electron emission regions 16 may be formed through adding organic materials such as vehicle and binder to a powdered electron emission material, printing the mixture to form a paste with a reasonable viscosity, screen-printing the paste onto the cathode electrodes 11, and drying and firing it. Alternatively, the electron emission regions 16 may be formed through chemical vapor deposition, sputtering, or direct growth.

As the first and second insulating layers 12 and 14 are formed using insulating materials with different firing and softening temperatures, breakage or deformation of the first insulating layer 12 and the gate electrodes 13, due to the later formation of a second insulating layer 14, can be avoided. Accordingly, it becomes possible to form the deposition structure of the first and second insulating layers 12 and 14 in a stable manner.

It is explained above in relation to a FEA type electron emission display such that the electron emission regions are formed with a material emitting electrons under the application of an electric field, and the electron emission is controlled by the driving electrodes formed with the cathode and the gate electrodes. However, the structure according to the present invention is not limited to the FEA type electron emission device, but may be altered in various manners.

With the electron emission device described above with reference to various exemplary embodiments, the deposition structure of the first and second insulating layers can be stabilized. Furthermore, the emission efficiency of the electron emission regions is increased due to the thickness of the first insulating layer, and the electron beam focusing efficiency is increased due to the thickness of the second insulating layer, thereby enhancing the effect of intercepting the anode electric field with respect to the electron emission regions. The color representation of the display screen is also enhanced due to the increased beam focusing efficiency.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims, and equivalents thereof.

What is claimed is:

1. An electron emission device comprising:
a first substrate;
first and second electrodes formed on the first substrate and insulated from each other by a first insulating layer interposed therebetween;
electron emission regions electrically coupled to the first electrode;
a focusing electrode formed on the first and second electrodes; and
a second insulating layer interposed between the focusing electrode and the first and second electrodes, and having an opening exposing the electron emission regions,
wherein the first and second insulating layers each have a thickness of 1 μm or more, and the first insulating layer has a softening temperature higher than a softening temperature of the second insulating layer by 30° C. or more.

2. The electron emission device of claim 1, wherein the softening temperature of the first insulating layer is higher than a firing temperature of the second insulating layer.

3. The electron emission device of claim 1, wherein the first insulating layer has a thickness of 3 μm or more.

4. The electron emission device of claim 1, wherein the second insulating layer has a thickness of 5 μm or more.

5. The electron emission device of claim 1, wherein the first electrode, the first insulating layer, and the second electrode are sequentially formed on the first substrate, and the first insulating layer and the second electrode have opening portions at least partially exposing portions of the first electrode on which the electron emission regions are formed.

6. The electron emission device of claim 1, wherein the second electrode, the first insulating layer, and the first electrode are sequentially formed on the first substrate, and the electron emission regions contact a peripheral side of the first electrode.

7. The electron emission device of claim 1, wherein the electron emission regions comprise a material selected from the group consisting of carbon nanotube, graphite, graphite nanofiber, diamond, diamond-like carbon, C₆₀, and silicon nanowire.

8. The electron emission device of claim 1, further comprising at least one anode electrode formed on a second substrate facing and spaced from the first substrate, and phosphor layers formed on a surface of the anode electrode.

9. An electron emission device comprising:
a first substrate;
first and second electrodes formed on the first substrate and insulated from each other by a first insulating layer interposed therebetween;
electron emission regions electrically coupled to the first electrode; and
a focusing electrode formed on the first and second electrodes;
a second insulating layer interposed between the focusing electrode and the first and second electrodes and having an opening exposing the electron emission regions,
wherein the first and second insulating layers each have a thickness of 1 μm or more, and the first insulating layer has a firing temperature higher than a firing temperature of the second insulating layer by 50° C. or more.

10. The electron emission device of claim 9, wherein the first insulating layer has a softening temperature higher than the firing temperature of the second insulating layer.

11. The electron emission device of claim 9, wherein the first insulating layer has a thickness of 3 μm or more.

12. The electron emission device of claim 9, wherein the second insulating layer has a thickness of 5 μm or more.

13. The electron emission device of claim 9, wherein the first electrode, the first insulating layer, and the second electrode are sequentially formed on the first substrate, and the first insulating layer and the second electrode have opening portions partially exposing portions of the first electrode on which the electron emission regions are formed.

14. The electron emission device of claim 9, wherein the second electrode, the first insulating layer, and the first electrode are sequentially formed on the first substrate, and the electron emission regions contact a peripheral side of the first electrode.

15. The electron emission device of claim 9, wherein the electron emission regions comprise a material selected from the group consisting of carbon nanotube, graphite, graphite nanofiber, diamond, diamond-like carbon, C₆₀, and silicon nanowire.

16. The electron emission device of claim 9, further comprising at least one anode electrode formed on a second substrate facing and spaced from the first substrate, and phosphor layers formed on a surface of the anode electrode.

17. An electron emission device comprising:
a substrate;
first and second electrodes formed on the substrate and insulated from each other by a first insulating layer interposed therebetween;
electron emission regions electrically coupled to the first electrode;
a focusing electrode formed on the first and second electrodes; and
a second insulating layer interposed between the focusing electrode and the first and second electrodes and having openings exposing the electron emission regions,
wherein the first and second insulating layers each have a thickness of 1 μm or more, and a softening temperature of the first insulating layer is higher than a firing temperature of the second insulating layer.

18. The electron emission device of claim 17, wherein the softening temperature of the first insulating layer is higher than a softening temperature of the second insulating layer by 30° C. or more.

19. The electron emission device of claim 17, wherein a firing temperature of the first insulating layer is higher than the firing temperature of the second insulating layer by 50° C. or more.

20. The electron emission device of claim 17, wherein the first insulating layer has a thickness of 3 μm, and the second insulating layer has a thickness of 5 μm or more.
